(19) United States
(12) Patent Application Publication
(10) Pub. No.: US 2026/0280099 A1
(43) Pub. Date: Sep. 17, 2026

(54) CAVITY ANTENNA AND ELECTRONIC DEVICE

(71) Applicant: Honor Device Co., Ltd., Shenzhen (CN)

(72) Inventors: Aofang ZHANG, Shenzhen (CN); Yang LU, Shenzhen (CN); Shaojie CHU, Shenzhen (CN); Ning MA, Shenzhen (CN)

(21) Appl. No.: 19/677,138

(22) Filed: May 14, 2026

Related U.S. Application Data
(63) Continuation of application No. PCT/CN2024/106736, filed on Jul. 22, 2024.

(30) Foreign Application Priority Data
Nov. 15, 2023 (CN) 202323105787.1

(51) Int. Cl. H01Q 1/22

(52) U.S. Cl. CPC H01Q 1/22

(57) ABSTRACT

This application provides a cavity antenna and an electronic device. The cavity antenna includes a metal backplane, a dielectric substrate, and a flexible printed circuit board. The dielectric substrate is located between the flexible printed circuit board and the metal backplane. The flexible printed circuit board is electrically connected to the metal backplane. The flexible printed circuit board includes a body part and a bending plate. The body part is provided with an avoidance hole. The avoidance hole is spaced apart from a peripheral surface of the body part. The bending plate is fixedly connected to a hole wall of the avoidance hole and is bendable relative to the body part. When the bending plate is bent relative to the body part, the bending plate is electrically connected to the metal backplane.

### CROSS-REFERENCE TO RELATED APPLICATIONS

This application is a continuation of International Application No. PCT/CN2024/106736, filed on Jul. 22, 2024, which claims priority to Chinese Patent Application No. 202323105787.1, filed on Nov. 15, 2023, both of which are incorporated herein by reference in their entireties.

### TECHNICAL FIELD

This application relates to the field of electronic device technologies, and in particular, to a cavity antenna and an electronic device.

### BACKGROUND

With the continuous development of science and technology, electronic devices such as tablet computers are widely used in daily life and work of people, and have become indispensable daily products for people. To implement wireless communication of an electronic device, a current electronic device is usually designed with many antennas. However, the antenna is affected by an ambient environment, causing a change of an operating frequency of the antenna, and affecting wireless communication of the electronic device.

### SUMMARY

This application provides a cavity antenna and an electronic device, to reduce impact of an ambient environment on the antenna, avoid a change of an operating frequency of the antenna, and ensure wireless communication of the electronic device.

According to a first aspect, this application provides a cavity antenna, including a metal backplane, a dielectric substrate, and a flexible printed circuit board. The dielectric substrate and the flexible printed circuit board are both mounted on an inner side of the metal backplane. The flexible printed circuit board covers a part of the dielectric substrate and is electrically connected to the metal backplane. The flexible printed circuit board and the metal backplane together define the cavity antenna. The flexible printed circuit board includes a body part and a bending plate. The body part is provided with an avoidance hole. The avoidance hole extends through the body part in a thickness direction of the body part and is spaced apart from a peripheral surface of the body part. The bending plate is fixedly connected to a hole wall of the avoidance hole and is bendable relative to the body part.

When the bending plate is bent relative to the body part, the bending plate extends into the inside of the cavity antenna and is electrically connected to the metal backplane.

In the cavity antenna shown in this application, the flexible printed circuit board may cover the dielectric substrate and is electrically connected to the metal backplane, to define the cavity antenna. The cavity antenna is configured for wireless communication of an electronic device. The bending plate is designed on the flexible printed circuit board, so that a large range and fine tuning of an operating frequency of the cavity antenna can be implemented based on a related design of a structure and size of the bending plate without improving a structure of the cavity antenna. In this way, impact of an ambient environment on the cavity antenna can be reduced, a change of the operating frequency of the cavity antenna can be avoided, and wireless communication of the electronic device can be ensured.

In an implementation, when the bending plate is bent relative to the body part, the bending plate is directly electrically connected to or electrically coupled to the metal backplane. When the bending plate is directly electrically connected to and electrically coupled to the metal backplane, resonance frequencies of the cavity antenna are different. When the bending plate is used by the cavity antenna, that the bending plate is directly electrically connected to the metal backplane or is electrically coupled to the metal backplane may be selected based on a target frequency of the cavity antenna, so that the resonance frequency of the cavity antenna approaches the target frequency. In this way, impact of the ambient environment on the cavity antenna can be reduced, a change of the operating frequency of the cavity antenna can be avoided, and wireless communication of the electronic device can be ensured.

In an implementation, when the bending plate is expanded relative to the body part, a resonance frequency fᵣ of the cavity antenna satisfies:

$${f}_{r} \approx \frac{c}{2 \sqrt{{ε}_{r}}} \sqrt{{( \frac{1}{{w}_{1}} )}^{2} + {( \frac{1}{2 {w}_{2}} )}^{2}} .$$

w₁ represents a length of the cavity antenna, w₂ represents a width of the cavity antenna, c represents speed of light, εᵣ represents a relative permittivity of the dielectric substrate, and f₀ represents a target frequency.

When fᵣ is less than f₀ and the bending plate is bent relative to the body part, the bending plate is directly electrically connected to the metal backplane, so that direct grounding is implemented, the resonance frequency fᵣ of the cavity antenna can be increased, and the resonance frequency fᵣ of the cavity antenna is tuned to the target frequency f₀. In this way, impact of the ambient environment on the cavity antenna can be reduced, a change of the operating frequency of the cavity antenna can be avoided, and wireless communication of the electronic device can be ensured.

When fᵣ is greater than f₀ and the bending plate is bent relative to the body part, the bending plate is electrically coupled to the metal backplane, so that coupling grounding is implemented, the resonance frequency fᵣ of the cavity antenna can be lowered, and the resonance frequency fᵣ of the cavity antenna is tuned to the target frequency f₀. In this way, impact of the ambient environment on the cavity antenna can be reduced, a change of the operating frequency of the cavity antenna can be avoided, and wireless communication of the electronic device can be ensured.

In an implementation, there are a plurality of avoidance holes and a plurality of bending plates. The plurality of avoidance holes are spaced apart from each other, and each bending plate is fixedly connected to a hole wall of one of the avoidance holes. One or more bending plates is used, and the one or more bending plates are bent relative to the body part, so that the resonance frequency of the cavity antenna approaches the target frequency, to implement tuning of the cavity antenna. In this way, impact of the ambient environment on the cavity antenna can be reduced, a change of the operating frequency of the cavity antenna can be avoided, and wireless communication of the electronic device can be ensured.

In an implementation, there are two avoidance holes and two bending plates. The two avoidance holes are respectively a first avoidance hole and a second avoidance hole. The two bending plates are respectively a first bending plate and a second bending plate. The first bending plate is fixedly connected to a hole wall of the first avoidance hole, and the second bending plate is fixedly connected to a hole wall of the second avoidance hole. The first bending plate and/or the second bending plate are used, and the first bending plate and/or the second bending plate are/is bent relative to the body part, so that the resonance frequency of the cavity antenna approaches the target frequency, to implement tuning of the cavity antenna. In this way, impact of the ambient environment on the cavity antenna can be reduced, a change of the operating frequency of the cavity antenna can be avoided, and wireless communication of the electronic device can be ensured.

In an implementation, the resonance frequency of the cavity antenna is 2.45 GHz. To be specific, the cavity antenna may transmit a Wi-Fi signal; the operating frequency band of the cavity antenna is a Wi-Fi 2.4 G frequency band; and the operating frequency of the cavity antenna is from 2.415 GHz to 2.485 GHZ, and a center frequency is 2.45 GHz.

In an implementation, the cavity antenna may transmit a Bluetooth signal.

In an implementation, the length w₁ of the cavity antenna is equal to 55 mm, the width w₂ of the cavity antenna is equal to 25 mm, the relative permittivity Er of the dielectric substrate is equal to 3.15, the first bending plate and the second bending plate are both bent relative to the body part and are both directly electrically connected to the metal backplane, and a width L₁ of the first bending plate is equal to 3 mm and a width L₂ of the second bending plate is equal to 5 mm, or the width L₁ of the first bending plate is equal to 5 mm and the width L₂ of the second bending plate is equal to 2 mm.

When the cavity antenna uses both the first bending plate and the second bending plate, bending plates with different widths are used, so that fine tuning of the resonance frequency of the cavity antenna can be implemented, and the resonance frequency of the cavity antenna approaches the target frequency, to implement tuning of the cavity antenna. In this way, impact of the ambient environment on the cavity antenna can be reduced, a change of the operating frequency of the cavity antenna can be avoided, and wireless communication of the electronic device can be ensured.

In an implementation, the length w₁ of the cavity antenna is equal to 55 mm, the width w₂ of the cavity antenna is equal to 25 mm, the relative permittivity εᵣ of the dielectric substrate is equal to 3.0, the first bending plate is bent relative to the body part and is directly electrically connected to the metal backplane, and a width L₁ of the first bending plate is equal to 3 mm.

When the relative permittivity εᵣ of the dielectric substrate in the cavity antenna is adjusted to 3.0, without a change of a size of the cavity antenna, the first bending plate is used, the second bending plate is not used, and the width of the first bending plate is adjusted to that L₁=3 mm, so that the resonance frequency of the cavity antenna can be tuned to that the target frequency f₀=2.45 GHz. In this way, impact of the ambient environment on the cavity antenna can be reduced, a change of the operating frequency of the cavity antenna can be avoided, and wireless communication of the electronic device can be ensured.

In an implementation, the cavity antenna includes a first peripheral surface, a second peripheral surface, and a chamfered peripheral surface. The chamfered peripheral surface is connected between the first peripheral surface and the second peripheral surface. In other words, one corner of the cavity antenna is cut off.

The length w₁ of the cavity antenna is equal to 55 mm, the width w₂ of the cavity antenna is equal to 25 mm, and the relative permittivity εᵣ of the dielectric substrate is equal to 3.15, the first bending plate and the second bending plate are both bent relative to the body part and are both directly electrically connected to the metal backplane, a width L₁ of the first bending plate is equal to 3 mm, and a width L₂ of the second bending plate is equal to 2 mm.

When one corner of the cavity antenna is cut off, without a change of another size of the cavity antenna, the first bending plate and the second bending plate are used, the width of the first bending plate is adjusted to that L₁=3 mm, and the width of the second bending plate is adjusted to that L₂=2 mm, so that the resonance frequency of the cavity antenna can be tuned to that the target frequency f₀=2.45 GHz. In this way, impact of the ambient environment on the cavity antenna can be reduced, a change of the operating frequency of the cavity antenna can be avoided, and wireless communication of the electronic device can be ensured.

In an implementation, the bending plate includes an electrical connection part and a bendable part. The electrical connection part is spaced apart from the body part, and the bendable part is fixedly connected between the hole wall of the avoidance hole and the electrical connection part.

When the bending plate is bent relative to the body part, the electrical connection part is located between the body part and the metal backplane, faces the body part, and is electrically connected to the metal backplane, and the bendable part is bent relative to the body part and the electrical connection part.

In an implementation, when the bending plate is expanded relative to the body part, the electrical connection part and the bendable part are located at the avoidance hole. The avoidance hole may avoid the bending plate, to avoid that the hole wall of the avoidance hole affects bending of the bending plate relative to the body part.

In an implementation, the flexible printed circuit board further includes a mounting part and a bending part. The mounting part is located between the body part and the metal backplane, is spaced apart from and faces the body part, and is further electrically connected to the metal backplane. The bending part is fixedly connected between the hole wall of the avoidance hole and the mounting part, and is bent relative to the body part and the mounting part.

In an implementation, the cavity antenna further includes a first conductive adhesive layer. The first conductive adhesive layer is electrically connected between the mounting part and the metal backplane, to establish an electrical connection between the flexible printed circuit board and the metal backplane.

In an implementation, when the flexible printed circuit board is in an expanded state, the body part and the bending plate are in a same plane.

In an implementation, the body part is further provided with a notch. The notch extends through the body part in the thickness direction of the body part, extends through the peripheral surface of the body part, and is spaced apart from the avoidance hole. The notch may be in communication with the inside and the outside of the cavity antenna, so that the inside of the cavity antenna is in an open state. The notch may be used for signal radiation of the cavity antenna.

According to a second aspect, this application provides an electronic device, including any one of the foregoing cavity antennas, a processor, and a connecting wire. The processor and the connecting wire are both mounted on an inner side of the metal backplane. The connecting wire is electrically connected between the processor and the flexible printed circuit board.

In the electronic device in this application, the bending plate is designed on the flexible printed circuit board, so that a large range and fine tuning of an operating frequency of the cavity antenna can be implemented based on a related design of a structure and size of the bending plate without improving a structure of the cavity antenna. In this way, impact of an ambient environment on the cavity antenna can be reduced, a change of the operating frequency of the cavity antenna can be avoided, and wireless communication of the electronic device can be ensured.

The connecting wire is electrically connected to a position of the body part close to the notch. A region close to the notch in the body part may be used as a feeding region for the cavity antenna, to implement coupling feeding or direct feeding of the cavity antenna.

In an implementation, the electronic device further includes a frame. The metal backplane is mounted on a side of the frame. The dielectric substrate and the flexible printed circuit board are both mounted on an inner side of the frame.

In an implementation, the electronic device further includes a display screen. The display screen is mounted on a side of the frame that faces away from the metal backplane. The display screen includes a display panel and a metal support plate. The metal support plate is mounted on a non-display side of the display panel and is electrically connected to the body part.

In an implementation, the electronic device further includes a second conductive adhesive layer. The second conductive adhesive layer is electrically connected between the body part and the metal support plate, to establish an electrical connection between the flexible printed circuit board and the metal support plate.

In the electronic device shown in this application, the flexible printed circuit board may cover the dielectric substrate and is electrically connected to the metal backplane, to define the cavity antenna. The cavity antenna is configured for wireless communication of the electronic device. The bending plate is designed on the flexible printed circuit board, so that a large range and fine tuning of the operating frequency of the cavity antenna can be implemented based on a related design of the structure and size of the bending plate without improving the structure of the cavity antenna. In this way, impact of the ambient environment on the cavity antenna can be reduced, a change of the operating frequency of the cavity antenna can be avoided, and wireless communication of the electronic device can be ensured.

### BRIEF DESCRIPTION OF DRAWINGS

To describe technical solutions in embodiments of this application more clearly, the following describes the accompanying drawings required for embodiments of this application.

FIG. 1 is a schematic diagram of a structure of an electronic device according to an embodiment of this application;

FIG. 2 is a schematic exploded view of a structure of the electronic device shown in FIG. 1;

FIG. 3 is a schematic diagram of a structure of a flexible printed circuit board and a second conductive adhesive layer in the electronic device shown in FIG. 2;

FIG. 4 is a schematic diagram of a structure of the flexible printed circuit board and a first conductive adhesive layer in the electronic device shown in FIG. 2 from another angle;

FIG. 5 is a schematic diagram of a structure of the flexible printed circuit board that is in the electronic device shown in FIG. 2 and that is in an expanded state;

FIG. 6 is a schematic diagram of a simple structure of a cavity antenna in the electronic device shown in FIG. 2 according to a first embodiment;

FIG. 7 is a schematic diagram of a cross-sectional structure of the cavity antenna shown in FIG. 6 when a first bending plate is used;

FIG. 8 is a S11 curve diagram of the cavity antenna shown in FIG. 6 in different use states;

FIG. 9 is a schematic diagram of a simple structure of the cavity antenna in the electronic device shown in FIG. 2 according to a second embodiment;

FIG. 10 is a S11 curve diagram of the cavity antenna shown in FIG. 9 in a first implementation to a fifth implementation;

FIG. 11 is a S11 curve diagram of the cavity antenna shown in FIG. 9 in the fifth implementation to a ninth implementation;

FIG. 12 is a schematic diagram of a simple structure of the cavity antenna in the electronic device shown in FIG. 2 according to a third embodiment;

FIG. 13 is a schematic diagram of a cross-sectional structure of the cavity antenna shown in FIG. 12;

FIG. 14 is a S11 curve diagram of the cavity antenna shown in FIG. 12 in a first implementation to a fourth implementation;

FIG. 15 is a schematic diagram of a simple structure of the cavity antenna in the electronic device shown in FIG. 2 according to a fourth embodiment;

FIG. 16 is a S11 curve diagram of the cavity antenna shown in FIG. 15;

FIG. 17 is a schematic diagram of a simple structure of the cavity antenna in the electronic device shown in FIG. 2 according to a fifth embodiment; and

FIG. 18 is a S11 curve diagram of the cavity antenna shown in FIG. 17.

### DESCRIPTION OF EMBODIMENTS

The following clearly and completely describes technical solutions in embodiments of this application with reference to the accompanying drawings in embodiments of this application.

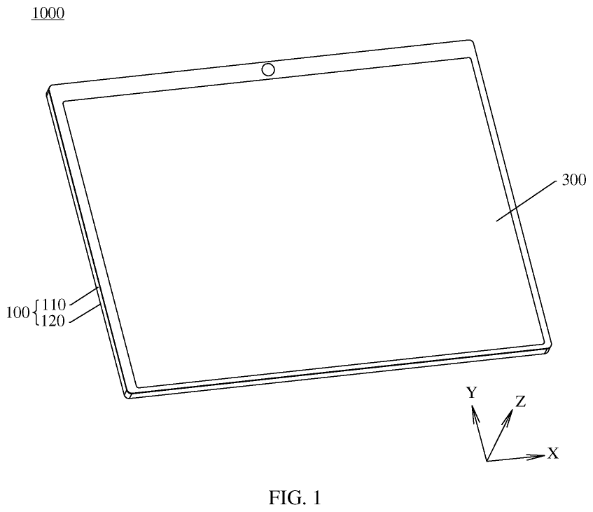

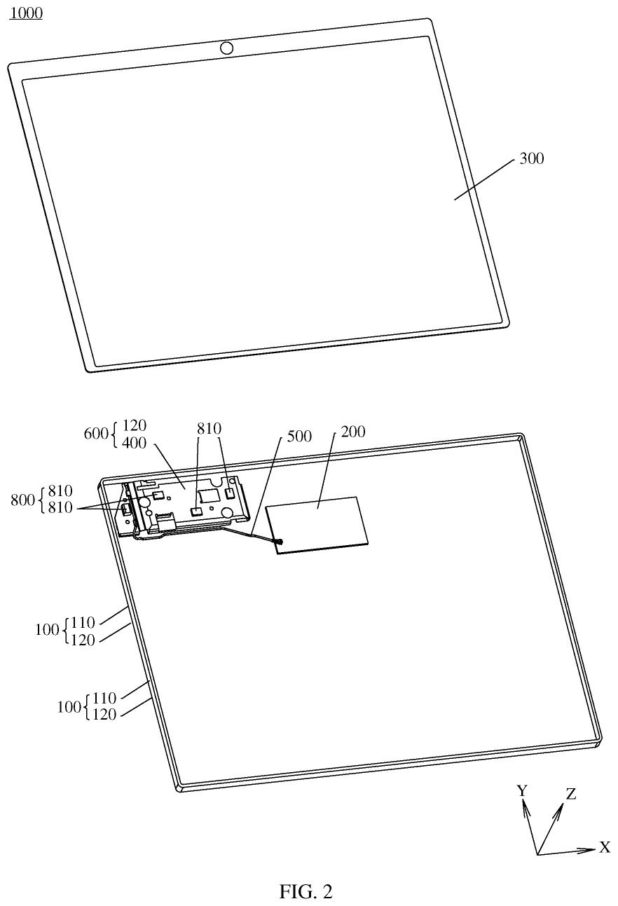

Refer to FIG. 1 and FIG. 2. FIG. 1 is a schematic diagram of a structure of an electronic device 1000 according to an embodiment of this application. FIG. 2 is a schematic exploded diagram of a structure of the electronic device 1000 shown in FIG. 1.

The electronic device 1000 may be an electronic product having a wireless communication function, for example, a tablet computer, a mobile phone, a notebook computer, an on-board unit, a smartwatch, a smart band, or a point of sale terminal (POS). Next, in embodiments of this application, an example in which the electronic device 1000 is a tablet computer is used for description. For ease of description, a width direction of the electronic device 1000 is defined as an X-axis direction, a length direction of the electronic device 1000 is defined as a Y-axis direction, and a thickness direction of the electronic device 1000 is defined as a Z-axis direction. The X-axis direction, the Y-axis direction, and the Z-axis direction are perpendicular to each other.

It should be noted that the qualifiers such as parallel and perpendicular for a relative positional relationship in embodiments of this application are all for a current process level and are not absolutely strict definitions in the mathematical sense. A light deviation is allowed, and approximately parallel and approximately perpendicular are both acceptable. For example, that A is parallel to B means that A is parallel or approximately parallel to B, and an included angle between A and B is between 0 degrees and 10 degrees. For example, that A is perpendicular to B means that A is perpendicular or approximately perpendicular to B, and an included angle between A and B is between 80 degrees and 100 degrees.

The electronic device 1000 includes a housing 100, a circuit board 200, a processor (not shown in the figures), a display screen 300, a dielectric substrate (not shown in the figures), a flexible printed circuit board 400, and a connecting wire 500. The circuit board 200, the processor, the display screen 300, the dielectric substrate, the flexible printed circuit board (FPC) 400, and the connecting wire 500 are all mounted in the housing 100.

The housing 100 includes a frame 110 and a metal backplane 120. The metal backplane 120 is mounted on a side of the frame 110. The metal backplane 120 may be made of a metal material, for example, iron or aluminum. For example, the frame 110 and the metal backplane 120 may be integrally formed, to ensure overall strength of the housing 100. In some other embodiments, the frame 110 and the metal backplane 120 may be assembled to form an integral structure, or the metal backplane 120 may be mounted on the frame 110 in a detachable manner, to facilitate maintenance and replacement of an internal component or module of the electronic device 1000.

The circuit board 200 and the processor are both mounted on an inner side of the frame 110. The processor may be mounted on the circuit board 200 and electrically connected to the circuit board 200. The circuit board 200 may be a mainboard of the electronic device 1000, and the processor may be a central processing unit (CPU) of the electronic device 1000. It should be noted that orientation terms “inside” and “outside” in this application are all described with reference to orientations shown in FIG. 1. Using a direction toward the inside of the electronic device 1000 as “inside” and a direction toward the outside of the electronic device 1000 as “outside” does not indicate or imply that a mentioned apparatus or element needs to have a particular orientation or needs to be constructed and operated in a particular orientation, and therefore should not be construed as a limitation on this application.

The display screen 300 may be mounted on another side of the frame 110. Specifically, the display screen 300 is mounted on a side of the frame 110 that faces away from the metal backplane 120. In other words, the display screen 300 and the metal backplane 120 are respectively mounted on two opposite sides of the frame 110. When a user uses the electronic device 1000, the display screen 300 is placed toward the user, and the metal backplane 120 is placed away from the user. The display screen 300 is electrically connected to the circuit board 200, to establish an electrical connection with the processor. The display screen 300 may receive, by using the circuit board 200, a display signal sent by the processor, and display information such as an image or texts based on the display signal.

The display screen 300 includes a display panel and a metal support plate. The metal support plate is mounted on a non-display side of the display panel and supports the display panel. For example, the display screen 300 may be a display panel, for example, a liquid crystal display (LCD) panel or an organic light-emitting diode (OLED) display panel. The metal support plate may be a metal frame made of iron.

The dielectric substrate, the flexible printed circuit board 400, and the connecting wire 500 are all mounted on an inner side of the frame 110 and the metal backplane 120. Specifically, the dielectric substrate, the flexible printed circuit board 400, and the connecting wire 500 are all located at an upper left corner of the frame 110. The dielectric substrate may be supported by an insulation material. The flexible printed circuit board 400 covers a part of the dielectric substrate, and is electrically connected to both the metal backplane 120 and the display screen 300. The connecting wire 500 is electrically connected between a feeding point of the flexible printed circuit board 400 and the circuit board 200, to establish an electrical connection between the flexible printed circuit board 400 and the processor.

In an implementation, the electronic device 1000 includes a cavity antenna 600. The cavity antenna 600 includes the metal backplane 120, the dielectric substrate, and the flexible printed circuit board 400. In other words, the flexible printed circuit board 400, the dielectric substrate, and the metal backplane 120 may together define the cavity antenna 600. A metal layer in the flexible printed circuit board 400, the dielectric substrate, and the metal backplane 120 may together define the cavity antenna 600. The cavity antenna 600 may transmit a Bluetooth signal or a Wi-Fi signal.

The processor may transmit an antenna signal to the connecting wire 500 by using the circuit board 200. The connecting wire 500 may transmit, from the feeding point of the flexible printed circuit board 400 to the cavity antenna 600, the antenna signal sent by the processor. The cavity antenna 600 may radiate a signal to the outside of the electronic device 1000 based on the antenna signal sent by the processor, to implement signal transmission of the electronic device 1000. The cavity antenna 600 may further receive an external antenna signal of the electronic device 1000, and transmits the received external antenna signal from the feeding point of the flexible printed circuit board 400 to the connecting wire 500. The connecting wire 500 transmits the external antenna signal from the circuit board 200 to the processor, to implement signal reception of the electronic device 1000. Therefore, wireless communication of the electronic device 1000 is implemented.

It should be noted that, orientation terms such as “up”, “down”, “left”, and “right” in this application are all described with reference to the orientations shown in FIG. 1. Using a positive direction of the Y axis as “up”, a negative direction of the Y axis as “down”, a positive direction of the X axis as “right”, and a negative direction of the X axis as “left” does not indicate or imply that the mentioned apparatus or element needs to have a particular orientation or needs to be constructed and operated in a particular orientation, and therefore should not be understood as a limitation on this application.

In addition, the electronic device 1000 further includes a first conductive adhesive layer (not shown in the figures) and a second conductive adhesive layer 800. The first conductive adhesive layer is located between the flexible printed circuit board 400 and the metal backplane 120, and is electrically connected between the flexible printed circuit board 400 and the metal backplane 120, to establish an electrical connection between the flexible printed circuit board 400 and the metal backplane 120. The first conductive adhesive layer includes a plurality of first conductive adhesive sub-parts. The plurality of first conductive adhesive sub-parts are spaced apart, are located between the flexible printed circuit board 400 and the metal backplane 120, and are electrically connected between the flexible printed circuit board 400 and the metal backplane 120. The second conductive adhesive layer 800 is located between the flexible printed circuit board 400 and the metal support plate of the display screen 300, and is electrically connected between the flexible printed circuit board 400 and the metal support plate, to establish a single link between the flexible printed circuit board 400 and the display screen 300. The second conductive adhesive layer 800 includes a plurality of second conductive adhesive sub-parts 810. The plurality of second conductive adhesive sub-parts 810 are spaced apart, are located between the flexible printed circuit board 400 and the metal support plate of the display screen 300, and are electrically connected between the flexible printed circuit board 400 and the metal support plate. For example, the first conductive adhesive layer and the second conductive adhesive layer 800 are each a conductive foam adhesive.

It should be noted that, during a use process of the electronic device 1000, the cavity antenna 600 is affected by an ambient environment, causing a change of an operating frequency of the cavity antenna 600, and affecting the wireless communication function of the electronic device 1000. Generally, the operating frequency of the cavity antenna 600 may be tuned by adjusting a size of the cavity antenna 600. However, because an internal structure of the electronic device 1000 is very precise, a size change of the cavity antenna 600 affects other components of the electronic device 1000.

In the electronic device 1000 shown in this embodiment, fine tuning of the operating frequency of the cavity antenna 600 can be implemented without a size change of the cavity antenna 600. In this way, impact of the ambient environment on the cavity antenna 600 is reduced, a change of the operating frequency of the cavity antenna 600 is avoided, and the wireless communication function of the electronic device 1000 is ensured. Next, the cavity antenna 600 of the electronic device 1000 is described in detail.

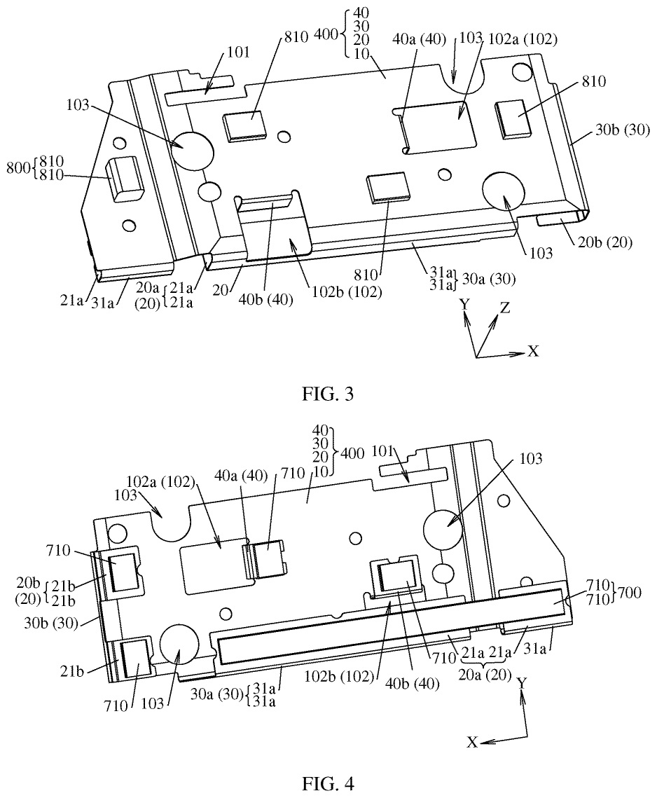

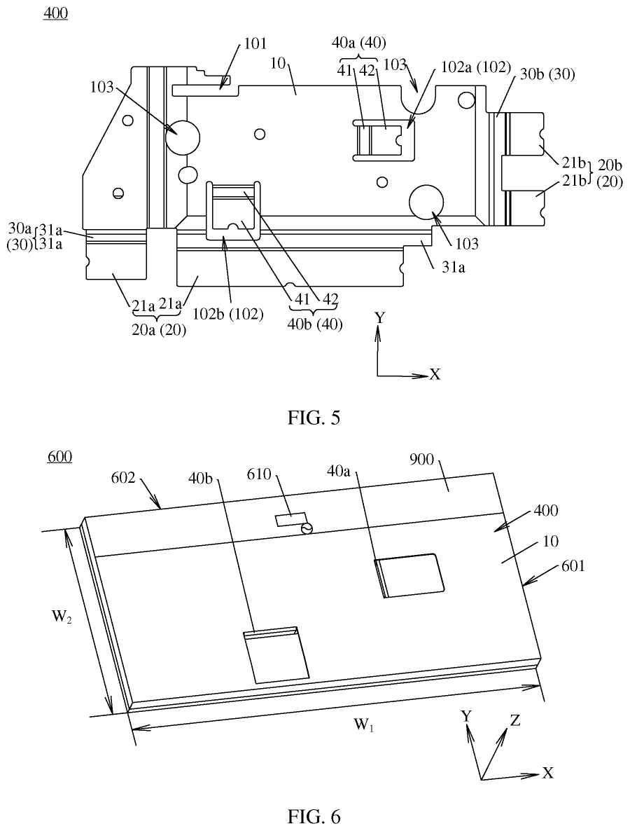

Refer to FIG. 3 to FIG. 5. FIG. 3 is a schematic diagram of a structure of the flexible printed circuit board 400 and the second conductive adhesive layer 800 in the electronic device 1000 shown in FIG. 2. FIG. 4 is a schematic diagram of a structure of the flexible printed circuit board 400 in the electronic device 1000 and the first conductive adhesive layer 700 shown in FIG. 2 from another angle. FIG. 5 is a schematic diagram of a structure of the flexible printed circuit board 400 that is in the electronic device 1000 shown in FIG. 2 and that is in an expanded state.

The flexible printed circuit board 400 includes a body part 10, a mounting part 20, a bending part 30, and a bending plate 40. The mounting part 20 is located on a bottom side of the body part 10, is spaced apart from, and faces the body part 10. The bending part 30 is fixedly connected between the body part 10 and the mounting part 20. The bending plate 40 is fixedly connected to the body part 10, is bendable relative to the body part 10, and is spaced apart from the mounting part 20 and the bending part 30. The body part 10, the mounting part 20, the bending part 30, and the bending plate 40 may be integrally formed.

It should be noted that orientation terms such as “top” and “bottom” in embodiments of this application are all described with reference to orientations shown in FIG. 4. Using a positive direction of the Z axis as “top” and a negative direction of the Z axis as “bottom” does not indicate or imply that the mentioned apparatus or element needs to have a particular orientation or needs to be constructed and operated in a particular orientation, and therefore should not be construed as a limitation on this application.

The body part 10 is provided with a notch 101, an avoidance hole 102, and a positioning hole 103. The notch 101, the avoidance hole 102, and the positioning hole 103 all extends through the body part 10 in a thickness direction of the body part 10 (the Z-axis direction shown in the figures). Specifically, the notch 101 is located on an edge of the body part 10 and extends through a peripheral surface of the body part 10. The notch 101 may be in communication with the inside and the outside of the cavity antenna 600, so that the inside of the cavity antenna 600 is in an open state. The notch 101 may be used for signal radiation of the cavity antenna 600. For example, the notch 101 is located on an upper portion of the body part 10. The upper portion of the body part 10 further provides a feeding point. The feeding point is disposed close to the notch 101. In this case, the upper portion of the body part 10 may be used as a feeding region for the cavity antenna 600, to implement coupling feeding or direct feeding of the cavity antenna 600. In some other embodiments, the notch 101 may alternatively be located on a lower portion, a left portion, or a right portion of the body part 10. A position of the notch 101 is not specifically limited in this application.

The avoidance hole 102 is located at the middle of the body part 10, and is spaced apart from both the notch 101 and the peripheral surface of the body part 10. There are two avoidance holes 102, and the two avoidance holes 102 are spaced apart from each other. The two avoidance holes 102 are respectively a first avoidance hole 102a and a second avoidance hole 102b. For example, the first avoidance hole 102a and the second avoidance hole 102b are both rectangular holes. A length direction of the first avoidance hole 102a is parallel to the Y-axis direction, and a length direction of the second avoidance hole 102b is parallel to the X-axis direction. In some other embodiments, there may be one, three, or more avoidance holes 102. A quantity and shapes of the avoidance holes 102 are not specifically limited in this application.

The positioning hole 103 is spaced apart from both the notch 101 and the avoidance hole 102. The positioning hole 103 may be used for mounting a fastener, for example, a screw or a bolt. Alternatively, the positioning hole 103 may be used for mounting and positioning. For example, there are three positioning holes 103, and the three positioning holes 103 are spaced apart from each other. In some other embodiments, there may be two or less or four or more positioning holes 103. A quantity and positions of positioning holes 103 are not specifically limited in this application.

The mounting part 20 is spaced apart from and faces the body part 10 in the Z-axis direction, and is electrically connected to the metal backplane 120. For example, the mounting part 20 is parallel to a XY plane. There are two mounting parts 20, and the two mounting parts 20 are spaced apart from each other. The two mounting parts 20 are respectively a first mounting part 20a and a second mounting part 20b. The first mounting part 20a is spaced apart from and faces the lower portion of the body part 10, and is electrically connected to the metal backplane 120. The first mounting part 20a includes two first mounting sub-parts 21a. The two first mounting parts 20a are spaced apart in the X-axis direction, and are both electrically connected to the metal backplane 120. The second mounting part 20b is spaced apart from and faces the right portion of the body part 10, and is electrically connected to the metal backplane 120. The second mounting part 20b includes two second mounting sub-parts 21b. The two second mounting parts 20b are spaced apart in the X-axis direction, and are both electrically connected to the metal backplane 120. In some other embodiments, there may be one, three, or more mounting parts 20. A quantity and positions of the mounting parts 20 are not specifically limited in this application.

The bending part 30 is fixedly connected between the peripheral surface of the body part 10 and a peripheral surface of the mounting part 20, and is bent relative to both the body part 10 and the mounting part 20. There are two bending parts 30, and the two bending parts 30 are spaced apart from each other. The two bending parts 30 are respectively a first bending part 30a and a second bending part 30b. The first bending part 30a is fixedly connected between the lower portion of the body part 10 and the first mounting part 20a. The first bending part 30a includes two first bending sub-parts 31a, and each first bending sub-part 31a is fixedly connected between the body part 10 and one first mounting sub-part 21a. The two first bending sub-parts 31a are spaced apart in the X-axis direction. The second bending part 30b is fixedly connected between the right portion of the body part 10 and the second mounting part 20b. In some other embodiments, there may be one, three, or more bending parts 30. A quantity and positions of the bending parts 30 are not specifically limited in this application.

The bending plate 40 is fixedly connected to a hole wall of the avoidance hole 102, and is bendable relative to the body part 10. The bending plate 40 includes an electrical connection part 41 and a bendable part 42. The electrical connection part 41 is spaced apart from the body part 10. The bendable part 42 is fixedly connected between the electrical connection part 41 and the hole wall of the avoidance hole 102. The bending plate 40 has an expanded state and a bent state. When the bending plate 40 is in the expanded state, as shown in FIG. 5, the bending plate 40 is expanded relative to the body part 10, the bendable part 42 is expanded relative to the body part 10, and the electrical connection part 41 and the bendable part 42 may be both located in the avoidance hole 102. In this case, the bending plate 40 and the body part 10 may be in a same plane. As shown in FIG. 5, when the flexible printed circuit board 400 is in the expanded state, the body part 10, the mounting part 20, the bending part 30, and the bending plate 40 are all in a same plane.

When the bending plate 40 is in the bent state, as shown in FIG. 3 and FIG. 4, the bending plate 40 is bent relative to the body part 10, and the bending plate 40 extends into the inside of the cavity antenna 600, and is electrically connected to the metal backplane 120. The electrical connection part 41 is located on the bottom side of the body part 10, and is spaced apart from and faces the body part 10. The bendable part 42 is bent relative to the body part 10 and the electrical connection part 41. In this case, the electrical connection part 41 of the bending plate 40 is directly electrically connected to or electrically coupled to the metal backplane 120.

There are two bending plates 40, and the two bending plates 40 are spaced apart from each other. The two bending plates 40 are respectively a first bending plate 40a and a second bending plate 40b. The first bending plate 40a is fixedly connected to a hole wall of the first avoidance hole 102a, and the second bending plate 40b is fixedly connected to a hole wall of the second avoidance hole 102b. For example, when the first bending plate 40a and the second bending plate 40b are in the expanded state, the first bending plate 40a and the second bending plate 40b are both rectangular. A length direction of the first bending plate 40a is parallel to the length direction of the first avoidance hole 102a, and a length direction of the second bending plate 40b is parallel to the length direction of the second avoidance hole 102b. In some other embodiments, there may be one, three, or more bending plates 40. A quantity and positions of the bending plates 40 are not specifically limited in this application.

For example, the first conductive adhesive layer 700 includes five first conductive adhesive sub-parts 710, and the second conductive adhesive layer 800 includes four second conductive adhesive sub-parts 810. One first conductive adhesive sub-part 710 is disposed on bottom surfaces of the two first mounting sub-parts 21a of the first mounting part 20a, and is electrically connected between the first mounting part 20a and the metal backplane 120. Two first conductive adhesive sub-parts 710 are respectively disposed on bottom surfaces of the two second mounting sub-parts 21b of the second mounting part 20b, and are electrically connected between the second mounting part 20b and the metal backplane 120. Two first conductive adhesive sub-parts 710 are respectively disposed on bottom faces of the electrical connection parts 41 of the two bending plates 40. The four second conductive adhesive sub-parts 810 are all disposed on a top surface of the body part 10, are spaced apart from each other, and are electrically connected between the body part 10 and the metal support plate of the display screen 300.

Next, a structure of the cavity antenna 600 is specifically described by using a Wi-Fi 2.4 G frequency band as an example. The operating frequency of the cavity antenna 600 is 2.415 GHz to 2.485 GHz, and a center frequency is 2.45 GHz.

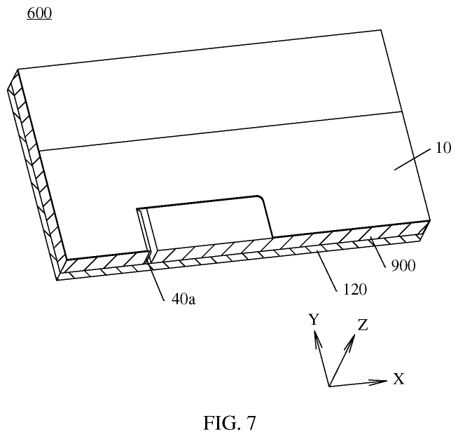

Refer to FIG. 6 and FIG. 7. FIG. 6 is a schematic diagram of a simple structure of the cavity antenna 600 in the electronic device 1000 shown in FIG. 2 according to a first embodiment. FIG. 7 is a schematic diagram of a cross-sectional structure of the cavity antenna 600 shown in FIG. 6 when the first bending plate 40a is used.

In this embodiment, the cavity antenna 600 includes a first peripheral surface 601 and a second peripheral surface 602. The first peripheral surface 601 is directly connected to the second peripheral surface 602. For the cavity antenna 600, a length is w₁, and a width is w₂. A relative permittivity of the dielectric substrate 900 is εᵣ. w₁=55 mm, w₂=25 mm, and εᵣ=3.15. A feeding point 610 of the cavity antenna 600 is disposed on the flexible printed circuit board 400.

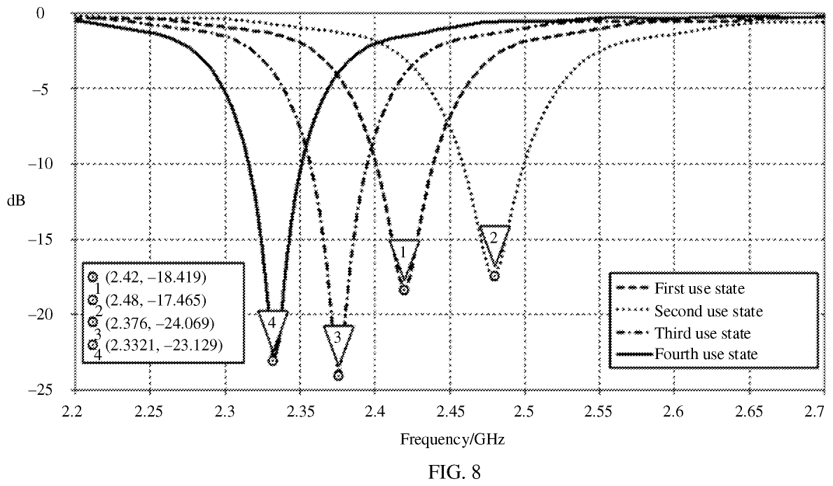

Refer to FIG. 8. FIG. 8 is a S11 curve diagram of the cavity antenna 600 shown in FIG. 6 in different use states. It should be understood that, in the curve diagram shown in FIG. 8, a horizontal axis represents a resonance frequency in a unit of GHz, and a vertical axis represents an energy reflection coefficient in a unit of dB.

In a first implementation, the cavity antenna 600 uses the first bending plate 40a but does not use the second bending plate 40b. Specifically, the first bending plate 40a is bent relative to the body part 10, and is directly electrically connected to the metal backplane 120, and the second bending plate 40b is expanded relative to the body part 10. The first bending plate 40a may be directly electrically connected to the metal backplane 120 by using the first conductive adhesive sub-part.

In a second implementation, the cavity antenna 600 uses the first bending plate 40a and the second bending plate 40b. Specifically, the first bending plate 40a and the second bending plate 40b are both bent relative to the body part 10, and are both electrically connected to the metal backplane 120. The first bending plate 40a and the second bending plate 40b may be both directly electrically connected to the metal backplane 120 by using the first conductive adhesive sub-part.

In a third implementation, the cavity antenna 600 does not use the first bending plate 40a but uses the second bending plate 40b. To be specific, the first bending plate 40a is expanded relative to the body part 10; and the second bending plate 40b is bent relative to the body part 10, and is electrically connected to the metal backplane 120. The second bending plate 40b may be directly electrically connected to the metal backplane 120 by using the first conductive adhesive sub-part.

In a fourth implementation, the cavity antenna 600 does not use the first bending plate 40a or the second bending plate 40b. To be specific, the first bending plate 40a and the second bending plate 40b are both expanded relative to the body part 10, and are both spaced apart from the metal backplane 120.

It can be learned from FIG. 8 that, when the cavity antenna 600 uses the first bending plate 40a but does not use the second bending plate 40b, the resonance frequency of the cavity antenna 600 is 2.42 GHz. When the cavity antenna 600 uses the first bending plate 40a and the second bending plate 40b, the resonance frequency of the cavity antenna 600 is 2.48 GHz. When the cavity antenna 600 does not use the first bending plate 40a but uses the second bending plate 40b, the resonance frequency of the cavity antenna 600 is 2.38 GHz. When the cavity antenna 600 does not use the first bending plate 40a or the second bending plate 40b, the resonance frequency of the cavity antenna 600 is 2.33 GHZ. In conclusion, when the structure of the cavity antenna 600 is not changed, the resonance frequency of the cavity antenna 600 can be tuned within a large range depending on whether the bending plate 40 is used.

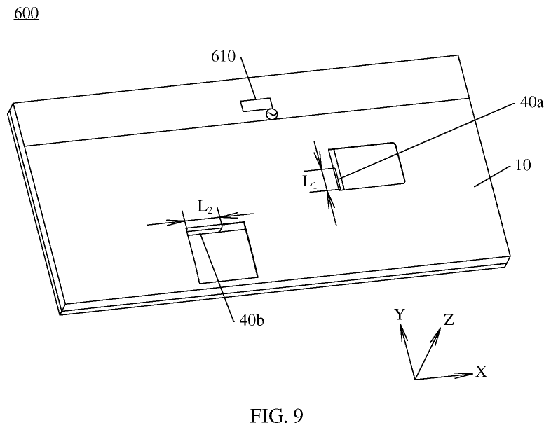

Refer to FIG. 9. FIG. 9 is a schematic diagram of a simple structure of the cavity antenna 600 in the electronic device 1000 shown in FIG. 2 according to a second embodiment.

A difference between the cavity antenna 600 in this embodiment and the cavity antenna 600 in the foregoing first embodiment lies in that the cavity antenna 600 uses the first bending plate 40a and the second bending plate 40b. Specifically, the first bending plate 40a and the second bending plate 40b are both bent relative to the body part 10, and are both electrically connected to the metal backplane 120. The first bending plate 40a and the second bending plate 40b may be both directly electrically connected to the metal backplane 120 by using the first conductive adhesive sub-part. In addition, a width of the first bending plate 40a is L₁, and a width of the second bending plate 40b is L₂. L₁ and L₂ are both greater than or equal to 1 mm and less than or equal to 5 mm.

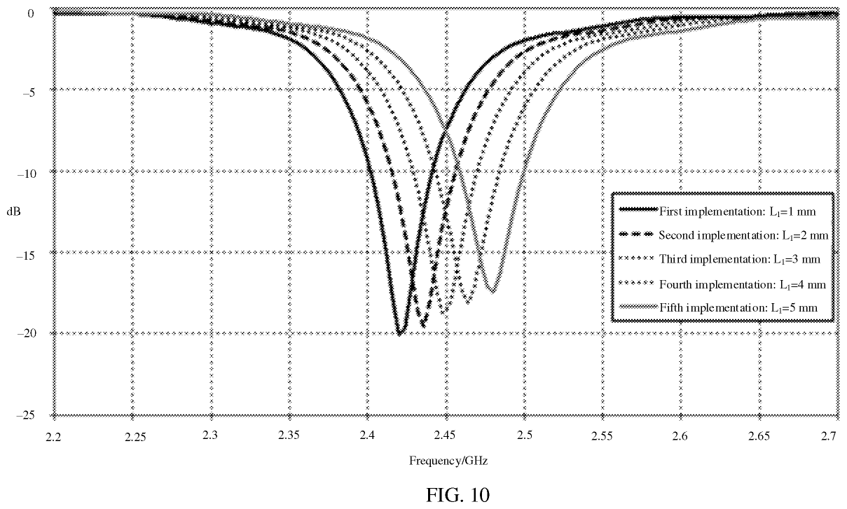

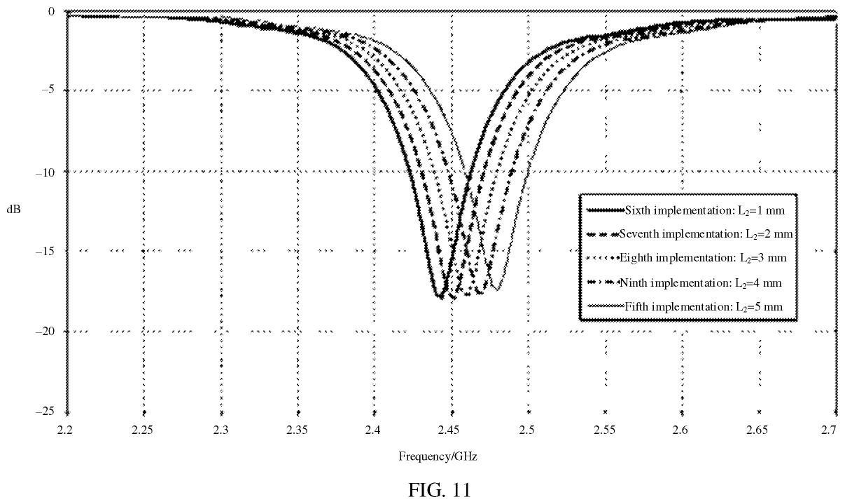

Refer to FIG. 10 and FIG. 11. FIG. 10 is a S11 curve diagram of the cavity antenna 600 shown in FIG. 9 in a first implementation to a fifth implementation. FIG. 11 is a S11 curve diagram of the cavity antenna 600 shown in FIG. 9 in the fifth implementation to a ninth implementation. It should be understood that, in the curve diagrams shown in FIG. 10 and FIG. 11, a horizontal axis represents a resonance frequency in a unit of GHz, and a vertical axis represents an energy reflection coefficient in a unit of dB.

In the first implementation, L₁=1 mm and L₂=5 mm. In the second implementation, L₁=2 mm and L₂=5 mm. In the third implementation, L₁=3 mm and L₂=5 mm. In the fourth implementation, L₁=4 mm and L₂=5 mm. In the fifth implementation, L₁=5 mm and L₂=5 mm. In the sixth implementation, L₁=5 mm and L₂=1 mm. In the seventh implementation, L₁=5 mm and L₂=2 mm. In the eighth implementation, L₁=5 mm and L₂=3 mm. In the ninth implementation, L₁=5 mm and L₂=4 mm.

It can be learned from FIG. 10 that, when the width L₂ of the second bending plate 40b is equal to 5 mm and remains unchanged, and the width L₁ of the first bending plate 40a changes from 1 mm to 5 mm, the resonance frequency of the cavity antenna 600 may be tuned from 2.42 GHz to 2.48 GHZ, to implement fine tuning of the resonance frequency of the cavity antenna 600. When L₁=3 mm, the resonance frequency of the cavity antenna 600 is tuned to a target frequency 2.45 GHz. It can be learned from FIG. 11 that, when the width L₁ of the first bending plate 40a is equal to 5 mm and remains unchanged, and the width L₂ of the second bending plate 40b changes from 1 mm to 5 mm, the resonance frequency of the cavity antenna 600 may be tuned from 2.44 GHz to 2.48 GHZ, to implement fine tuning of the resonance frequency of the cavity antenna 600. When L₂=2 mm, the resonance frequency of the cavity antenna 600 is tuned to a target frequency 2.45 GHz. Therefore, when L₁=3 mm and L₂=5 mm or L₁=5 mm and L₂=2 mm, the resonance frequency of the cavity antenna 600 may be tuned to the target frequency 2.45 GHz. In conclusion, bending plates 40 with different widths are used, so that the fine tuning of the resonance frequency of the cavity antenna 600 can be implemented, and the resonance frequency of the cavity antenna 600 approaches the target frequency, to implement tuning of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

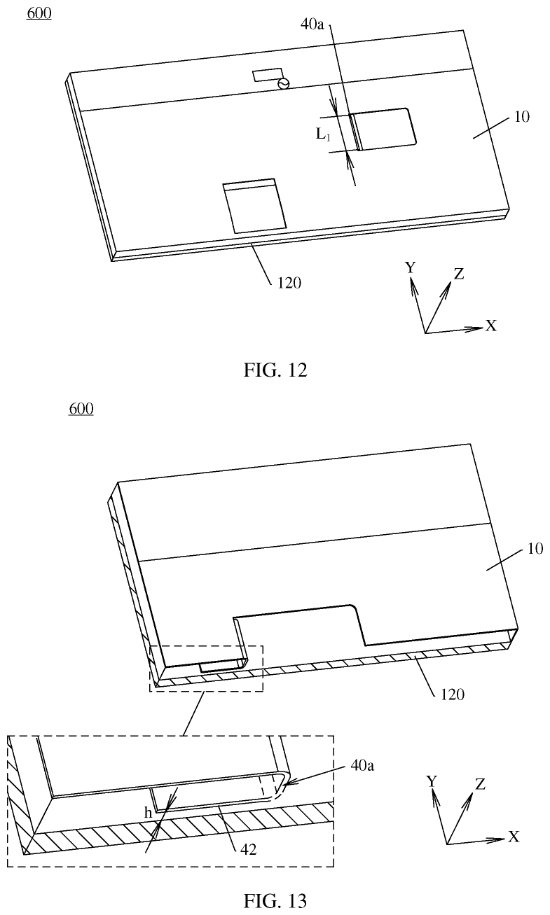

Refer to FIG. 12 and FIG. 13. FIG. 12 is a schematic diagram of a simple structure of the cavity antenna 600 in the electronic device 1000 shown in FIG. 2 according to a third embodiment. FIG. 13 is a schematic diagram of a cross-sectional structure of the cavity antenna 600 shown in FIG. 12. The dielectric substrate is not shown in FIG. 13.

A difference between the cavity antenna 600 in this embodiment and the cavity antenna 600 in the foregoing first embodiment lies in that the cavity antenna 600 uses the first bending plate 40a but does not use the second bending plate 40b. Specifically, the first bending plate 40a is bent relative to the body part 10, and the first bending plate 40a is coupled to the metal backplane 120. In a thickness direction (the Z axis direction shown in the figures) of the cavity antenna 600, a size of a coupling gap between the electrical connection part 42 of the first bending plate 40a and the metal backplane 120 is h. h is greater than 0 and less than or equal to 1 mm. For example, h is greater than or equal to 0.4 mm and less than or equal to 1 mm. In addition, a width L₁ of the first bending plate 40a is equal to 5 mm.

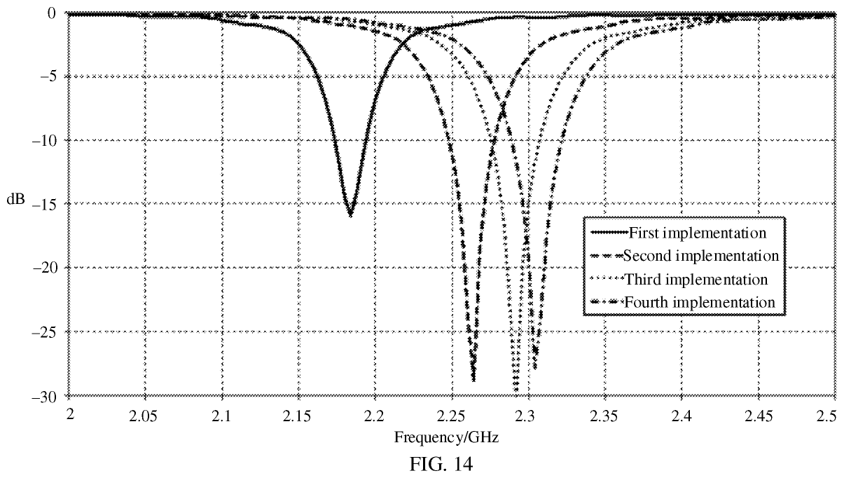

Refer to FIG. 14. FIG. 14 is a S11 curve diagram of the cavity antenna 600 shown in FIG. 12 in a first implementation to a fourth implementation. It should be understood that, in the curve diagram shown in FIG. 14, a horizontal axis represents a resonance frequency in a unit of GHz, and a vertical axis represents an energy reflection coefficient in a unit of dB.

It can be learned from FIG. 14 that, when the cavity antenna 600 uses the first bending plate 40a but does use the second bending plate 40b, the width L₁ of the first bending plate 40a is equal to 5 mm and remains unchanged, a size h of a coupling gap between the first bending plate 40a and the metal backplane 120 changes from 0.4 mm to 1 mm, and the resonance frequency of the cavity antenna 600 may be tuned from 2.18 GHz to 2.31 GHz.

It can be learned with reference to the foregoing first embodiment to third embodiment that, when the cavity antenna 600 does not use the bending plate 40, the resonance frequency of the cavity antenna 600 is 2.33 GHZ; when the cavity antenna 600 uses the bending plate 40, and the bending plate 40 is directly electrically connected to the metal backplane 120, the resonance frequency of the cavity antenna 600 is higher than the resonance frequency of the cavity antenna 600 without using the bending plate 40; and when the cavity antenna 600 uses the bending plate 40, and the bending plate 40 is electrically coupled to the metal backplane 120, the resonance frequency of the cavity antenna 600 is less than the resonance frequency of the cavity antenna 600 without using the bending plate 40. Therefore, when the bending plate 40 is used by the cavity antenna 600, that the bending plate 40 is directly electrically connected to the metal backplane 120 or is electrically coupled to the metal backplane 120 may be selected based on comparison between a target frequency f₀ and the resonance frequency of the cavity antenna 600 without using the bending plate 40, where f₀=2.45 GHz.

It should be understood that, when the cavity antenna 600 does not use the bending plate 40, the resonance frequency fᵣ of the cavity antenna 600 satisfies:

$${f}_{r} \approx \frac{c}{2 \sqrt{{ε}_{r}}} \sqrt{{( \frac{1}{{w}_{1}} )}^{2} + {( \frac{1}{2 {w}_{2}} )}^{2}} .$$

w₁ represents a length of the cavity antenna 600, w₂ represents a width of the cavity antenna 600, c represents speed of light, and εᵣ represents a relative permittivity of the dielectric substrate. It should be understood that, “≈” in the foregoing formula may indicate cases of “equal to”, “slightly less than”, and “slightly greater than”. For example, “≈” includes three cases of “equal to”, “slightly less than”, and “slightly greater than”.

When the cavity antenna 600 does not use the bending plate 40, the resonance frequency fᵣ is greater than the target frequency f₀. The bending plate 40 is used and the bending plate 40 is directly electrically connected to the metal backplane 120, so that direct grounding is implemented, the resonance frequency fᵣ of the cavity antenna 600 can be increased, and the resonance frequency fᵣ of the cavity antenna 600 is tuned to the target frequency f₀, to implement tuning of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

If the cavity antenna 600 does not use the bending plate 40, the resonance frequency fᵣ is less than the target frequency f₀. The bending plate 40 is used, and the bending plate 40 is electrically coupled to the metal backplane 120, so that coupling grounding is implemented, the resonance frequency fᵣ of the cavity antenna 600 can be lowered, and the resonance frequency fᵣ of the cavity antenna 600 is tuned to the target frequency f₀, to implement tuning of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

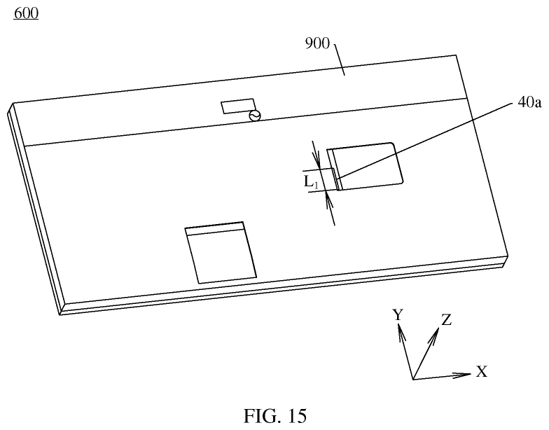

Refer to FIG. 15. FIG. 15 is a schematic diagram of a simple structure of the cavity antenna 600 in the electronic device 1000 shown in FIG. 2 according to a fourth embodiment.

A difference between the cavity antenna 600 in this embodiment and the cavity antenna 600 in the foregoing first embodiment lies in that the relative permittivity εᵣ of the dielectric substrate 900 is equal to 3.0. Specifically, the cavity antenna 600 uses the first bending plate 40a but does not use the second bending plate 40b. The first bending plate 40a is bent relative to the body part 10, and the first bending plate 40a is directly electrically connected to the metal backplane 120. In addition, a width L₁ of the first bending plate 40a is equal to 3 mm.

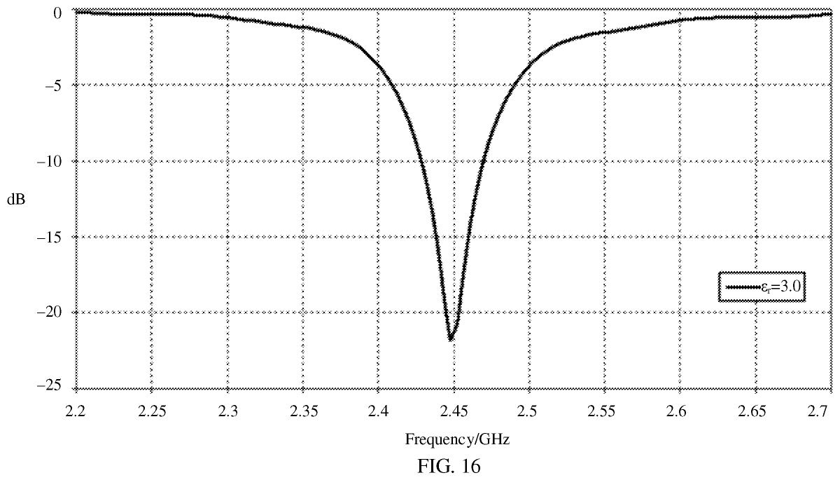

Refer to FIG. 16. FIG. 16 is a S11 curve diagram of the cavity antenna 600 shown in FIG. 15. It should be understood that, in the curve diagram shown in FIG. 16, a horizontal axis represents a resonance frequency in a unit of GHz, and a vertical axis represents an energy reflection coefficient in a unit of dB.

It may be understood that, after the relative permittivity εᵣ of the dielectric substrate 900 in the cavity antenna 600 is changed, the resonance frequency of the cavity antenna 600 also changes. The size of the cavity antenna 600 needs to be adjusted, so that the resonance frequency can be adjusted to a target frequency f₀. It can be learned from FIG. 16 that, when the relative permittivity εᵣ of the dielectric substrate 900 in the cavity antenna 600 is adjusted to 3.0, without a change of the size of the cavity antenna 600, the first bending plate 40a is used, the second bending plate 40b is not used, and the width of the first bending plate 40a is adjusted to that L₁=3 mm, so that the resonance frequency of the cavity antenna 600 can be tuned to that the target frequency f₀=2.45 GHz, to implement tuning of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

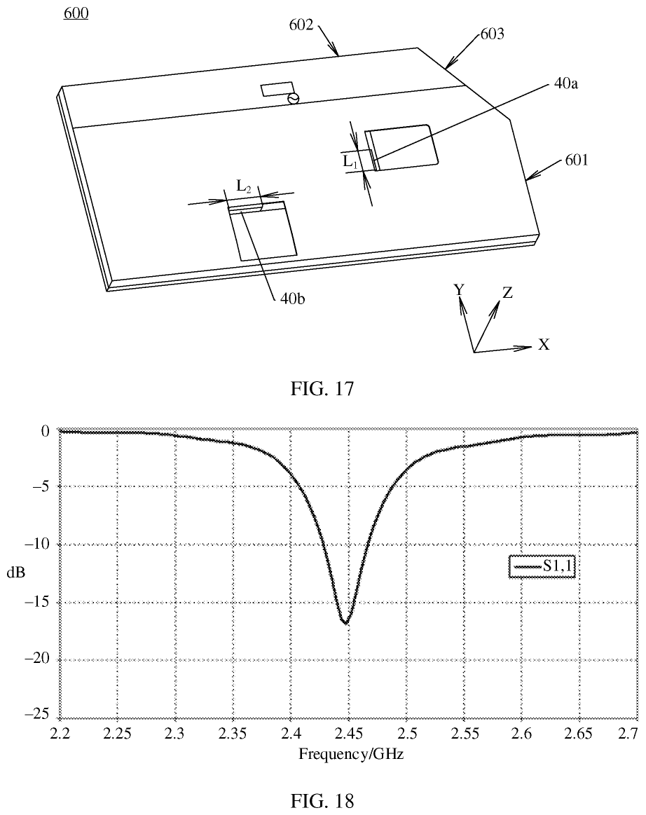

Refer to FIG. 17. FIG. 17 is a schematic diagram of a simple structure of the cavity antenna 600 in the electronic device 1000 shown in FIG. 2 according to a fifth embodiment.

A difference between the cavity antenna 600 in this embodiment and the cavity antenna 600 in the foregoing first embodiment lies in that the cavity antenna 600 includes the first peripheral surface 601, the second peripheral surface 602, and a chamfered peripheral surface 603. The chamfered peripheral surface 603 is connected between the first peripheral surface 601 and the second peripheral surface 602. In other words, in comparison with the cavity antenna 600 in the foregoing first embodiment, one corner of the cavity antenna 600 in this embodiment is cut off.

Specifically, the cavity antenna 600 uses the first bending plate 40a and the second bending plate 40b. The first bending plate 40a and the second bending plate 40b are both bent relative to the body part 10, and are directly electrically connected to the metal backplane 120. In addition, a width L₁ of the first bending plate 40a is equal to 3 mm, and a width L₂ of the second bending plate 40b is equal to 2 mm.

Refer to FIG. 18. FIG. 18 is a S11 curve diagram of the cavity antenna 600 shown in FIG. 17. It should be understood that, in the curve diagram shown in FIG. 18, a horizontal axis represents a resonance frequency in a unit of GHz, and a vertical axis represents an energy reflection coefficient in a unit of dB.

It may be understood that, when a partial structure of the cavity antenna 600 changes, usually, the resonance frequency of the cavity antenna 600 also changes, and the size of the cavity antenna 600 needs to be adjusted, so that the resonance frequency can be adjusted to a target frequency f₀. It can be learned from FIG. 18 that, when one corner of the cavity antenna 600 is cut off, without a change of another size of the cavity antenna 600, the first bending plate 40a and the second bending plate 40b are used, the width of the first bending plate 40a is adjusted to that L₁=3 mm, and the width of the second bending plate 40b is adjusted to that L₂=2 mm, so that the resonance frequency of the cavity antenna 600 can be tuned to that the target frequency f₀=2.45 GHZ, to implement tuning of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

In the electronic device 1000 shown in this application, the flexible printed circuit board 400 may cover the dielectric substrate 900 and is electrically connected to the metal backplane 120, to define the cavity antenna 600. The cavity antenna 600 is configured for wireless communication of the electronic device 1000. The bending plate 40 is designed on the flexible printed circuit board 400, so that a large range and fine tuning of the operating frequency of the cavity antenna 600 can be implemented based on a related design of a structure and size of the bending plate 40 without improving the structure of the cavity antenna 600. In this way, impact of the ambient environment on the cavity antenna 600 can be reduced, a change of the operating frequency of the cavity antenna 600 can be avoided, and wireless communication of the electronic device 1000 can be ensured.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Embodiments of this application and features in embodiments may be mutually combined, provided that no conflict occurs. Therefore, the protection scope of this application shall be subject to the protection scope of the claims.

What is claimed is:

1. A cavity antenna, comprising a metal backplane, a dielectric substrate, and a flexible printed circuit board, wherein the dielectric substrate is located between the flexible printed circuit board and the metal backplane, the flexible printed circuit board covers a part of the dielectric substrate and is electrically connected to the metal backplane, the flexible printed circuit board comprises a body part and a bending plate, the body part is provided with an avoidance hole, the avoidance hole extends through the body part in a thickness direction of the body part and is spaced apart from a peripheral surface of the body part, and the bending plate is fixedly connected to a hole wall of the avoidance hole and is bendable relative to the body part; and
when the bending plate is bent relative to the body part, the bending plate is electrically connected to the metal backplane.

2. The cavity antenna according to claim 1, wherein when the bending plate is bent relative to the body part, the bending plate is directly electrically connected to electrically coupled to the metal backplane.

3. The cavity antenna according to claim 2, wherein when the bending plate is expanded relative to the body part, a resonance frequency fᵣ of the cavity antenna satisfies:
$${f}_{r} \approx \frac{c}{2 \sqrt{{ε}_{r}}} \sqrt{{( \frac{1}{{w}_{1}} )}^{2} + {( \frac{1}{2 {w}_{2}} )}^{2}} ,$$
wherein
w₁ represents a length of the cavity antenna, w₂ represents a width of the cavity antenna, c represents speed of light, εᵣ represents a relative permittivity of the dielectric substrate, and f₀ represents a target frequency; and
when fᵣ is less than f₀ and the bending plate is bent relative to the body part, the bending plate is directly electrically connected to the metal backplane; or
when fᵣ is greater than f₀ and the bending plate is bent relative to the body part, the bending plate is electrically coupled to the metal backplane.

4. The cavity antenna according to claim 3, wherein there are a plurality of avoidance holes and a plurality of bending plates, the plurality of avoidance holes are spaced apart from each other, and each bending plate is fixedly connected to a hole wall of one of the avoidance holes.

5. The cavity antenna according to claim 4, wherein there are two avoidance holes and two bending plates, the two avoidance holes are respectively a first avoidance hole and a second avoidance hole, the two bending plates are respectively a first bending plate and a second bending plate, the first bending plate is fixedly connected to a hole wall of the first avoidance hole, and the second bending plate is fixedly connected to a hole wall of the second avoidance hole.

6. The cavity antenna according to claim 5, wherein the resonance frequency of the cavity antenna is 2.45 GHz.

7. The cavity antenna according to claim 6, wherein the length w₁ of the cavity antenna is equal to 55 mm, the width w₂ of the cavity antenna is equal to 25 mm, the relative permittivity εᵣ of the dielectric substrate is equal to 3.15, the first bending plate and the second bending plate are both bent relative to the body part and are both directly electrically connected to the metal backplane, and a width L₁ of the first bending plate is equal to 3 mm and a width L₂ of the second bending plate is equal to 5 mm, or the width L₁ of the first bending plate is equal to 5 mm and the width L₂ of the second bending plate is equal to 2 mm.

8. The cavity antenna according to claim 6, wherein the length w₁ of the cavity antenna is equal to 55 mm, the width w₂ of the cavity antenna is equal to 25 mm, the relative permittivity εᵣ of the dielectric substrate is equal to 3.0, the first bending plate is bent relative to the body part and is directly electrically connected to the metal backplane, and a width L₁ of the first bending plate is equal to 3 mm.

9. The cavity antenna according to claim 6, wherein the cavity antenna comprises a first peripheral surface, a second peripheral surface, and a chamfered peripheral surface, and the chamfered peripheral surface is connected between the first peripheral surface and the second peripheral surface; and
the length w₁ of the cavity antenna is equal to 55 mm, the width w₂ of the cavity antenna is equal to 25 mm, the relative permittivity εᵣ of the dielectric substrate is equal to 3.15, the first bending plate and the second bending plate are both bent relative to the body part and are both directly electrically connected to the metal backplane, a width L₁ of the first bending plate is equal to 3 mm, and a width L₂ of the second bending plate is equal to 2 mm.

10. The cavity antenna according to claim 1, wherein the bending plate comprises an electrical connection part and a bendable part, the electrical connection part is spaced apart from the body part, and the bendable part is fixedly connected between the hole wall of the avoidance hole and the electrical connection part; and
when the bending plate is bent relative to the body part, the electrical connection part is located between the body part and the metal backplane, faces the body part, and is electrically connected to the metal backplane, and the bendable part is bent relative to the body part and the electrical connection part.

11. The cavity antenna according to claim 10, wherein when the bending plate is expanded relative to the body part, the electrical connection part and the bendable part are located at the avoidance hole.

12. The cavity antenna according to claim 1, wherein the flexible printed circuit board further comprises a mounting part and a bending part, the mounting part is located between the body part and the metal backplane, is spaced apart from and faces the body part, and is further electrically connected to the metal backplane, and the bending part is fixedly connected between the hole wall of the avoidance hole and the mounting part, and is bent relative to the body part and the mounting part.

13. The cavity antenna according to claim 12, wherein the cavity antenna further comprises a first conductive adhesive layer, and the first conductive adhesive layer is electrically connected between the mounting part and the metal backplane.

14. The cavity antenna according to claim 1, wherein when the flexible printed circuit board is in an expanded state, the body part and the bending plate are in a same plane.

15. The cavity antenna according to claim 1, wherein the body part is further provided with a notch, and the notch extends through the body part in the thickness direction of the body part, extends through the peripheral surface of the body part, and is spaced apart from the avoidance hole.

16. An electronic device, comprising a cavity antenna, a processor, and a connecting wire, wherein the cavity antenna, comprising a metal backplane, a dielectric substrate, and a flexible printed circuit board, wherein the dielectric substrate is located between the flexible printed circuit board and the metal backplane, the flexible printed circuit board covers a part of the dielectric substrate and is electrically connected to the metal backplane, the flexible printed circuit board comprises a body part and a bending plate, the body part is provided with an avoidance hole, the avoidance hole extends through the body part in a thickness direction of the body part and is spaced apart from a peripheral surface of the body part, and the bending plate is fixedly connected to a hole wall of the avoidance hole and is bendable relative to the body part;
the bending plate is bent relative to the body part, and is electrically connected to the metal backplane;
the processor and the connecting wire are both mounted on an inner side of the metal backplane, one end of the connecting wire is electrically connected to the processor, and the other end of the connecting wire is electrically connected to the flexible printed circuit board.

17. The electronic device according to claim 16, wherein the electronic device further comprises a frame and a display screen, the metal backplane and the display screen are respectively mounted on opposite sides of the frame, and the dielectric substrate and the flexible printed circuit board are both located between the metal backplane and the display screen.

18. The electronic device according to claim 16, wherein the display screen comprises a display panel and a metal support plate, the metal support plate is mounted on a non-display side of the display panel; the electronic device further comprises a second conductive adhesive layer, and the second conductive adhesive layer is electrically connected between the body part and the metal support plate.

19. The electronic device according to claim 16, wherein there are two avoidance holes and two bending plates, the two avoidance holes are respectively a first avoidance hole and a second avoidance hole, the two bending plates are respectively a first bending plate and a second bending plate, the first bending plate is fixedly connected to a hole wall of the first avoidance hole, the second bending plate is fixedly connected to a hole wall of the second avoidance hole, and the resonance frequency of the cavity antenna is 2.45 GHz.

20. The electronic device according to claim 16, wherein the length w₁ of the cavity antenna is equal to 55 mm, the width w₂ of the cavity antenna is equal to 25 mm, the relative permittivity εᵣ of the dielectric substrate is equal to 3.15, the first bending plate and the second bending plate are both bent relative to the body part and are both directly electrically connected to the metal backplane, and a width L₁ of the first bending plate is equal to 3 mm and a width L₂ of the second bending plate is equal to 5 mm, or the width L₁ of the first bending plate is equal to 5 mm and the width L₂ of the second bending plate is equal to 2 mm.
